(19) United States
(12) Patent Application Publication
(10) Pub. No.: US 2013/0061643 A1
(43) Pub. Date: Mar. 14, 2013

(54) KEY

(71) Applicant: CHIU-HSIANG CHEN, PINGTUNG COUNTY (TW)

(72) Inventor: CHIU-HSIANG CHEN, PINGTUNG COUNTY (TW)

(73) Assignee: FEDERAL LOCK CO., LTD., PINGTUNG COUNTY (TW)

(21) Appl. No.: 13/231,115

(22) Filed: Sep. 13, 2011

(51) Int. Cl. E05B 19/02; E05B 47/06

(52) U.S. Cl. 70/276

(57) ABSTRACT

A key includes a shank having at least one groove and at least one recess, and the at least one groove has different lengths. At least one magnetic member is received in the at least one recess and a number of the at least one magnetic member is not more than a number of the at least one recess. The arrangements of the at least one recess, the at least one groove and the at least one magnetic member have multiple options. The magnetic members are located in different recesses and the magnetic poles of the magnetic members are arranged in different ways. The key is difficult to be copied and has higher safety standards.

### FIELD OF THE INVENTION

The present invention relates to a key, and more particularly, to a key having recesses of different depths and magnetic members are arranged in some of the recesses to prevent the key from being copied.

### BACKGROUND OF THE INVENTION

A conventional lock generally includes a core with beads and the key includes recesses of different depths so as to accommodate the beads to correctly rotate the core of the lock. In order to have higher safety standards, the beads are equipped with outer parts and inner parts which are movably located in the outer parts to form different combinations of the beads, such that the core cannot be easily copied. However, the conventional lock can be unlocked by using L-shaped tool or universal key to shift the beads to correct positions. Besides, there is a gap between the core and the cases, L-shaped tool or the like can be inserted into the gap and move the beads to unlock the lock. Therefore, the conventional locks with the beads are not safe as expected.

The key for the conventional locks includes recesses which are located corresponding to the beads, the arrangement of the recesses cannot change and the combination of the allocations of the recesses is limited. When the combination of allocations of the recesses are utilized, new models are needed to be developed and which takes time and cost. The conventional keys need to be improved.

The present invention intends to provide a key which has multiple different arrangement options for the recesses, grooves, and magnetic so as to improve the shortcomings of the conventional keys.

### SUMMARY OF THE INVENTION

The present invention relates to a key and comprises a shank having at least one recess. At least one magnetic member is received in the at least one recess and a number of the at least one magnetic member is not more than a number of the at least one recess.

Preferably, the at least one recess having no the at least one magnetic member received therein includes an engaging portion.

Preferably, the engaging portion has concavities of different depths.

Preferably, the engaging portion has convexes of different heights.

Preferably, the at least one recess is arranged unevenly spaced apart.

Preferably, the at least one recess includes different depths.

Preferably, the shank has at least one groove and the at least one groove has different lengths.

The primary object of the present invention is to provide a key which involves different combinations for arranging the positions of the grooves, the recesses and the magnetic members so as to prevent from being copied.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the first embodiment of the present invention;

FIG. 2 is an exploded view to show the first embodiment of the present invention;

FIG. 3 is a side view of the first embodiment of the present invention;

FIG. 4 shows the key of the present invention and the lock corresponding to the key;

FIG. 5 is a cross sectional view of the lock corresponding to the key of the present invention;

FIG. 6 shows that the magnetic members of the key of the present invention attract the beads in the lock;

FIG. 7 shows that the magnetic members of the key of the present invention magnetically repulse the beads in the lock, and

FIG. 8 shows the second embodiment of the present invention.

### DETAILED DESCRIPTION OF THE PREFERRED EMBODIMENT

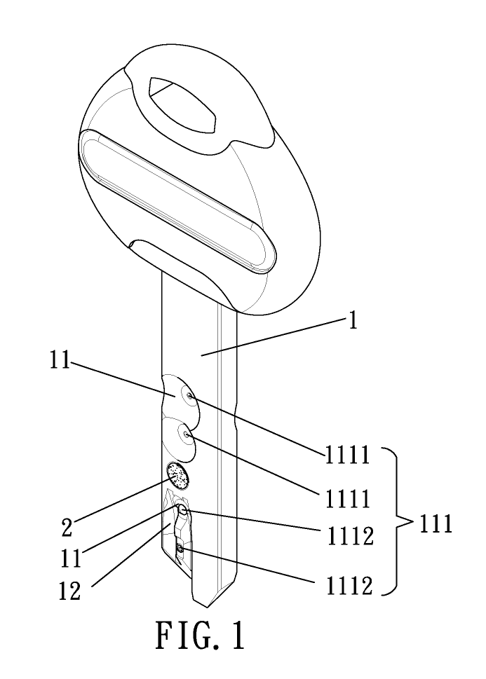

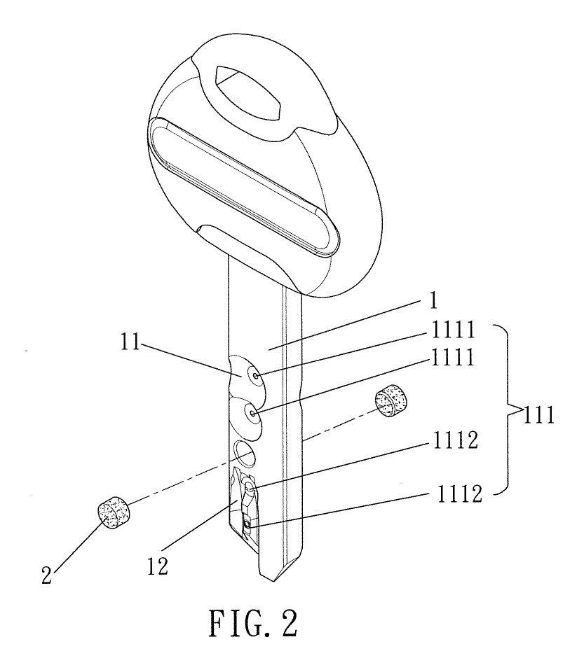

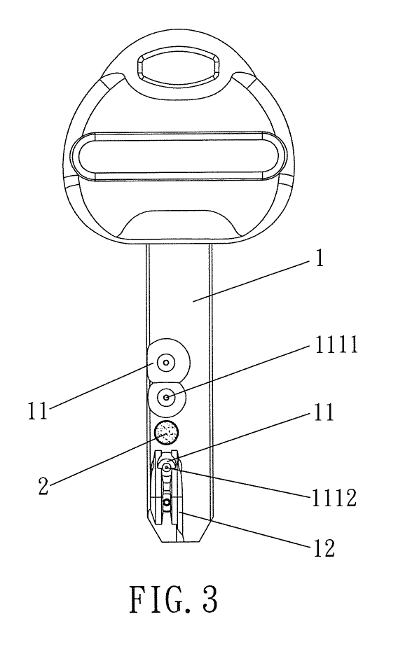

Referring to FIGS. 1 to 3, the key of the present invention comprises a shank 1 having at least one groove 12 and at least one recess 11. The at least one groove 12 has different lengths. The at least one recess 11 is arranged unevenly spaced apart and/or has different depths.

At least one magnetic member 2 is received in the at least one recess 11 and a number of the at least one magnetic member 2 is not more than a number of the at least one recess 11. The at least one recess 11 having no the at least one magnetic member 2 received therein includes an engaging portion 111. The engaging portion 111 has concavities of different depths and/or the engaging portion 111 has convexes of different heights.

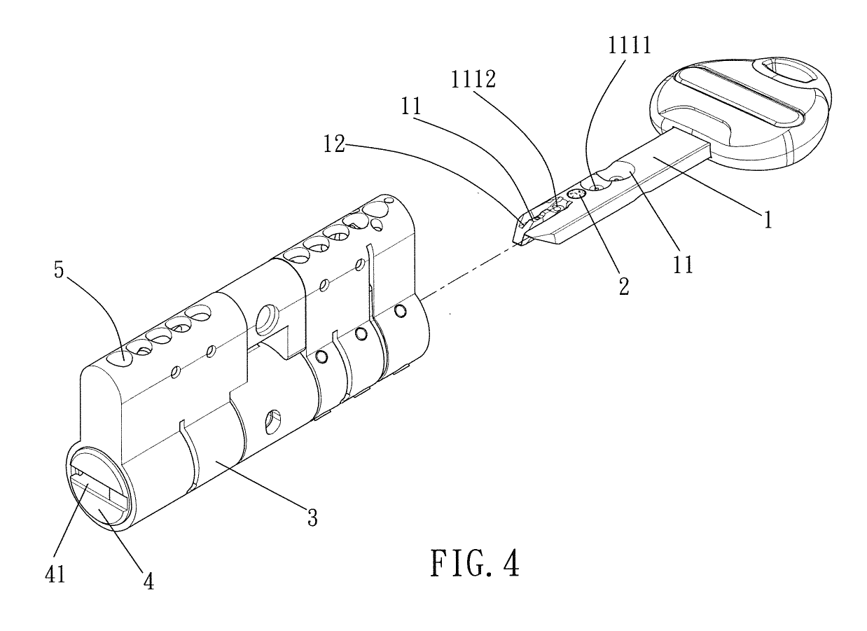

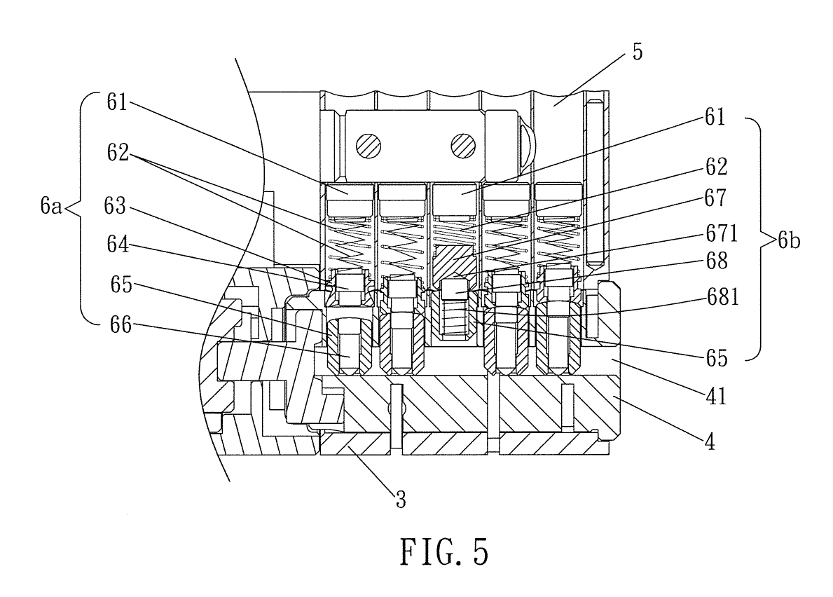

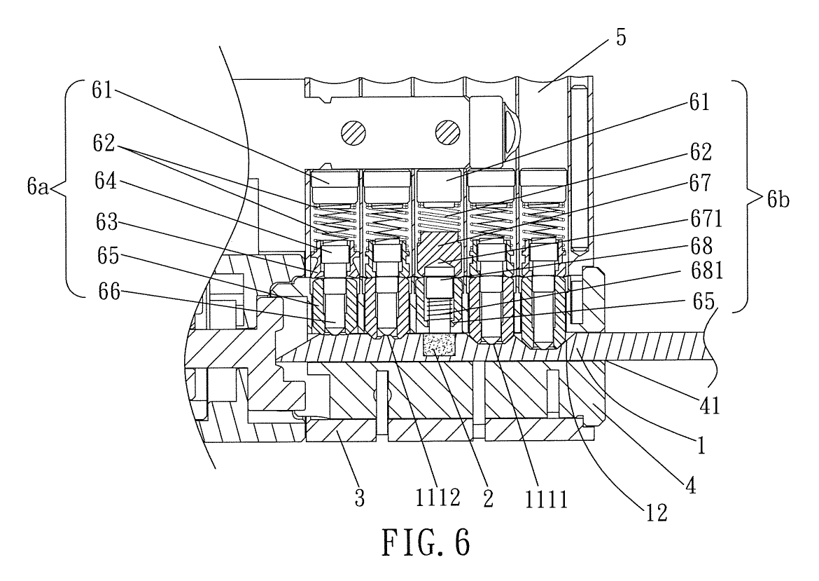

As shown in FIGS. 4 to 6, a lock is for the key of the present invention, and the lock includes a case 3 in which a core 4 is received. The core 4 has a keyhole 41 so that the shank 1 of the key of the present invention can be inserted therein. The shank 1 may have or may not have the grooves 12. There is at least one hole 5 defined between the case 3 and keyhole 41 of the core 4, and the hole 5 communicates with the recess 11 when the shank 1 of the key is inserted into the key hole 41. The holes 5 receive one of the bead units 6a, 6b, 6c. As shown in FIG. 6, the bead unit 6a includes a cover 61 and two springs 62 are located on two opposite sides of the cover 61. The spring 62 that is located on outside of the cover 61 is connected with a main bead 63 which has a sub-bead 64 received therein. The spring 62 that is located on the inside of the cover 61 is located corresponding to the sub-bead 64. A down bead 65 is located between the main bead 63 and the inside of the keyhole 41 and is in contact with the main bead 63. The recesses 11 have different positions, depths or shapes, so that the end of the down bead 65 of the bead unit 6a that is in contact with the inside of the keyhole 41 is located corresponding to the recess 11 that does not have the magnetic member 21 received therein. The down bead 65 has a down sub-bead 66 which is located corresponding to the sub-bead 64. The down sub-bead 66 is in contact with the sub-bead 64. The down sub-bead 66 has an end contacting the inside of the keyhole 41. By the concavities 1111 or convexes 1112 of different depths of the engaging portion 111, when the shank 1 is inserted into the keyhole 41, the contact surfaces of the main bead 63 and the down bead 65, and the contact surfaces of the sub-bead 64 and the down sub-bead 66 are located at the surfaces between the case 3 and the core 4. Therefore, the case 3, the core 4 and the bead unit 6a are not interfered. The bead unit 6b includes a cover 61 which is connected to a spring 62 and a bead 67 from an end of the case 3. The bead 67 has a room 671. A down bead 65 is located between the bead 67 and the inside of the keyhole 41. The down bead 65 has a magnetic bead 68 at the center thereof and the magnetic bead 68 is located corresponding to the room 671. The magnetic bead 68 is magnetically attracted to the magnetic member 2. A spring 681 is located between the inside of the keyhole 41 and the magnetic bead 68, so that when the magnetic bead 68 is not attracted by the magnetic member 2, the magnetic bead 68 is pushed by the spring 681 and contacts the inside of the room 671. The magnetic bead 68 is located between the case 3 and the core 4 which is then not rotatable. When the shank 1 is inserted into the keyhole 41, the magnetic bead 68 is attracted by the magnetic member 2 to compress the spring 681, such that the magnetic bead 68 is disengaged from the room 671. The contact surfaces of the down bead 65 and the bead 67 are located on the same plane with the surfaces between the case 3 and the core 4. The magnetic bead 68 does not block the plane so that the case 3, the core 4 and the bead unit 6b are not interfered.

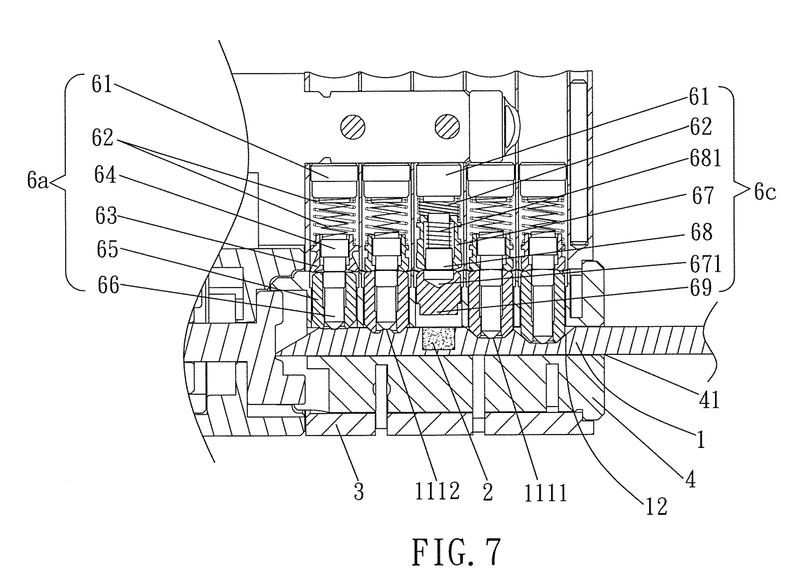

As shown in FIG. 7, the bead unit 6c includes a cover 61 which is connected to a spring 62 and a bead 67 from an end of the case 3. A down bead 69 is located between the bead 67 and the inside of the keyhole 41. A room 671 is located between the bead 67 and the down bead 69. A magnetic bead 68 is located in the room 671. The magnetic bead 68 and the magnetic member 2 are magnetically repulsed to each other. A spring 681 is located between the bead 67 and the magnetic bead 68, so that when the magnetic bead 68 is not repulsed by the magnetic member 2, the magnetic bead 68 is pushed by the spring 681 and contacts the down bead 69. The magnetic bead 68 is located between the case 3 and the core 4 which is then not rotatable. When the shank 1 is inserted into the keyhole 41, the magnetic bead 68 is repulsed by the magnetic member 2 to compress the spring 681, such that the magnetic bead 68 is disengaged from the room 671. The contact surfaces of the down bead 69 and the bead 67 are located on the same plane with the surfaces between the case 3 and the core 4. The magnetic bead 68 does not block the plane so that the case 3, the core 4 and the bead unit 6c are not interfered. The bead units 6a, 6b, 6c, the case 3 and the core 4 are not interfered, so that the core 4 can be rotated to unlock the lock.

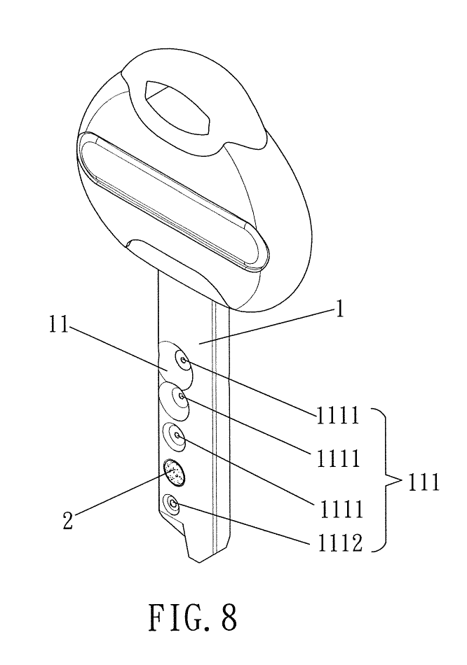

FIG. 8 shows the second embodiment and the difference compared to the first embodiment is that the shank 1 of the key does not have any groove 12 so that there is plenty of room for the recesses 11 and the magnetic members 2. The arrangements of the magnetic poles between the magnetic members 2 have more options.

The present invention has the following advantages:

1. The magnetic beads 68 of the bead units 6a, 6b, 6c can be arranged to be magnetically attracted or repulsed by the magnetic members 2, so that the lock cannot be unlocked by using L-shape tool or universal key.

2. By the recesses 11 of different depths, the engaging portions 111, the attraction or repulsion between the magnetic members 2 and the magnetic beads 68, and the existence of the groove 12, the present invention provides multiple combinations which allow the keys to be manufactured without worry of duplication.

3. The main beads 63 and sub-beads 64 and the magnetic beads 68 prevent from being picking by unauthorized persons and the bead units 6a, 6b, 6c have to be positioned corresponding to the recesses 11 or the magnetic members 2 so as to unlock the lock. The lock is safe and difficult to be unlocked.

While we have shown and described the embodiment in accordance with the present invention, it should be clear to those skilled in the art that further embodiments may be made without departing from the scope of the present invention.

1. A key comprising:
a shank having multiple recesses, at least one magnetic member received in the one of the multiple recesses and a number of the at least one magnetic member being less than a number of the recesses, the recesses without receiving the at least one magnetic member having an engaging portion, and
the shank having multiple grooves defined therein, the at least one magnetic member, the recesses, the engaging portions and the grooves being arranged on the key.

2. (canceled)

3. The key as claimed in claim 1, wherein the engaging portions have concavities of different depths.

4. The key as claimed in claim 1, wherein the engaging portions have convexes of different heights.

5. The key as claimed in claim 1, wherein the is recesses are arranged unevenly spaced apart.

6. The key as claimed in claim 1, wherein the recesses have different depths.

7. The key as claimed in claim 1, wherein the grooves in the shank have different lengths.
